(19) United States
(12) Patent Application Publication
(10) Pub. No.: US 2024/0214876 A1
(43) Pub. Date: Jun. 27, 2024

(54) LOSSLESS MULTICAST AND BROADCAST DATA TRANSMISSIONS IN HANDOVERS

(71) Applicant: ZTE Corporation, Shenzhen (CN)

(72) Inventors: Yansheng LIU, Shenzhen (CN); Zijiang MA, Shenzhen (CN); Dapeng LI, Shenzhen (CN)

(21) Appl. No.: 18/601,168

(22) Filed: Mar. 11, 2024

Related U.S. Application Data
(63) Continuation of application No. PCT/CN2021/125627, filed on Oct. 22, 2021.

(51) Int. Cl. H04W 36/00; H04W 36/08; H04W 36/30

(52) U.S. Cl. CPC H04W 36/0007; H04W 36/08; H04W 36/30

(57) ABSTRACT

Methods, apparatus, and systems that enable lossless Multicast and Broadcast Service (MBS) data transmissions in handovers between network nodes that may or may not support MBS are disclosed. In one example aspect, a wireless communication method includes requesting, upon determining by a first access node to perform a handover procedure for handing over a wireless device to a second access node, a switch of an ongoing multicast and broadcast services (MBS) session of the wireless device from a shared channel to a unicast tunnel with a core network. The method also includes initiating, after the switching, the handover procedure from the first access node to the second access node.

### CROSS-REFERENCE TO RELATED APPLICATION

This application is a continuation and claims priority to International Application No. PCT/2021/125627, filed on Oct. 22, 2021, the disclosure of which is hereby incorporated by reference herein in its entirety.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques that enable lossless Multicast and Broadcast Service (MBS) data transmissions in handovers between network nodes that may or may not support MBS.

In one example aspect, a wireless communication method includes requesting, upon determining by a first access node to perform a handover procedure for handing over a wireless device to a second access node, a switch of an ongoing multicast and broadcast services (MBS) session of the wireless device from a shared channel to a unicast tunnel with a core network. The method also includes initiating, after the switching, the handover procedure from the first access node to the second access node.

In another example aspect, a wireless communication method includes receiving, by the core network, a request message to from the first access node indicating a switch from a shared tunnel to a unicast tunnel for the MBS data and transmitting, from the core network in response to the switch to the unicast tunnel, the MBS data for the MBS session via the unicast tunnel.

In another example aspect, a communication apparatus is disclosed. The apparatus includes a processor that is configured to implement an above-described method.

In yet another example aspect, a computer-program storage medium is disclosed. The computer-program storage medium includes code stored thereon. The code, when executed by a processor, causes the processor to implement a described method.

These, and other, aspects are described in the present document.

### BRIEF DESCRIPTION OF DRAWINGS

FIG. 1 illustrates a legacy handover procedure that requires the source base station to relay user data from User Plane Function (UPF) to the target base station.

FIG. 2 is flowchart representation of a method of wireless communication in accordance with one or more embodiments of the present technology.

FIG. 3 is flowchart representation of another method of wireless communication in accordance with one or more embodiments of the present technology.

FIG. 4 illustrates an example sequence chart of signaling message between a source node and the core network in accordance with one or more embodiments of the present technology.

FIG. 5 is flowchart representation of another method of wireless communication in accordance with one or more embodiments of the present technology.

FIG. 6A illustrates an example sequence chart of signaling message between a source node, a target node, and the core network using the Xn-based handover procedure in accordance with one or more embodiments of the present technology.

FIG. 6B illustrates an example sequence chart of signaling message between a source node, a target node, and the core network using the NG-based handover procedure in accordance with one or more embodiments of the present technology.

FIG. 7 shows an example of a wireless communication system where techniques in accordance with one or more embodiments of the present technology can be applied.

FIG. 8 is a block diagram representation of a portion of a radio station in accordance with one or more embodiments of the present technology can be applied.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

Multicast/Broadcast Service (MBS) is a concept that network resources are used to send the same multimedia content to everyone (e.g., broadcasting) or to a group of subscribers (e.g., multicasting) rather than sending content to individual subscribers. With the development of the 5G New Radio (NR) technology, MBS has become one of the key aspects for Internet of Things (IoT) and Vehicle to Everything (V2X) communications. To improve transmission efficiency of the MBS data, it has been proposed to transport the MBS data packets from the Core Network (CN) to the access node (New-Generation Radio Access Node, NG-RAN) using a shared N3 tunnel instead of a unicast channel. The shared N3 tunnel is a tunnel that is defined for MBS use only.

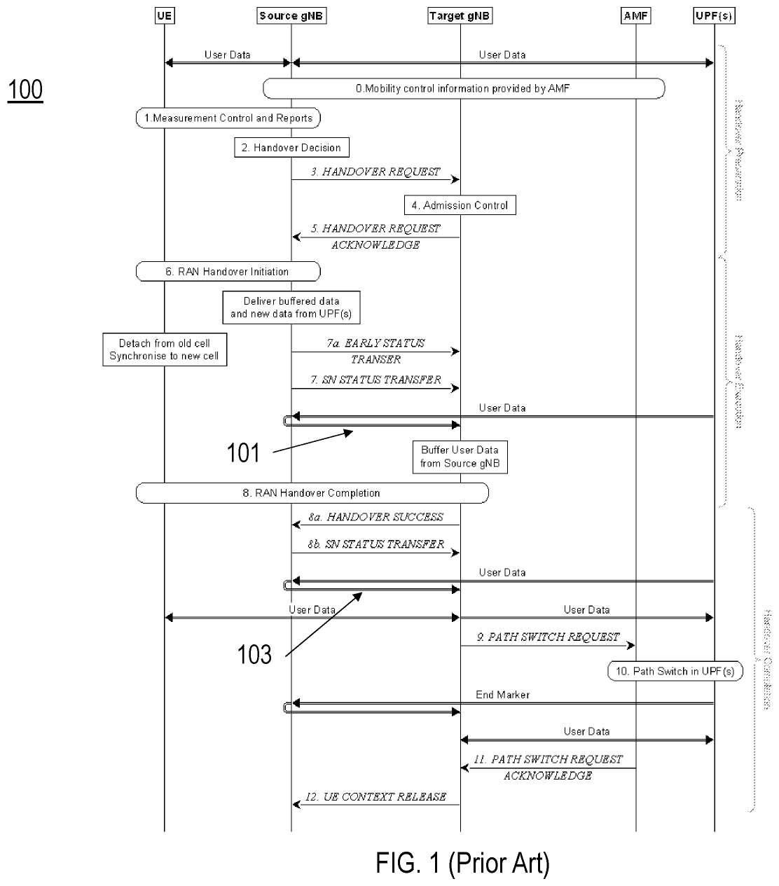

While MBS support has become increasingly prevalent, there still exist network nodes that do no support MBS. When a User Equipment (UE) moves in the network and is handed over from one cell that supports MBS (e.g., a first NG-RAN) to another cell that does not support MBS (e.g., a second NG-RAN or a legacy RAN), a shared N3 tunnel is not available between the second NG-RAN/legacy RAN and the CN, leading to potential data loss or complexity in ensuring MBS data integrity. FIG. 1 illustrates a legacy handover procedure that requires the source base station (Source gNB) to relay user data from User Plane Function (UPF) to the target base station (Target gNB). As shown in FIG. 1, because the Target gNB does not have an established shared N3 tunnel with the CN, MBS data is transmitted first to the Source gNB and relayed to the Target gNB, leading to excessive signaling overhead and potential delay. Furthermore, once the handover completes, the UE can no longer receive MBS data from the network via the Target gNB.

This patent document discloses techniques that can be implemented in various embodiments to ensure lossless MBS data transmissions during handover procedures between access nodes that may not support MBS with minimal signaling overhead. In particular, a unicast channel established between the RAN and the CN can be used to transmit MBS data packets to the RANs that do not support MBS, ensuring continuous support for MBS data transmissions. In some embodiments, the source node and/or the target node can have a buffer to temporarily store MBS data packets, and transfer any differences observed in the MBS data transmissions to ensure data integrity in the same MBS session. Some examples of the disclosed techniques are further described in the following example embodiment.

### Embodiment 1

In some cases, when the UE moves from a source node to a target node, the source node that supports MBS can determine that the target node does not support MBS prior to the initiation of the handover procedure. In those cases, the source node can indicate a switch to a unicast tunnel for MBS data transmission prior to the handover procedure to ensure that no data loss is incurred once the UE is handed over to the target node.

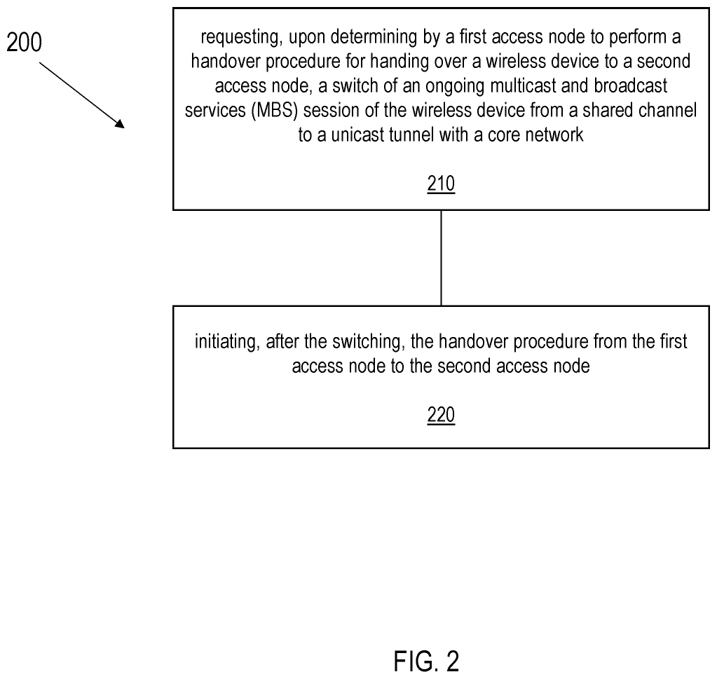

A first set of preferred solutions may include the following. FIG. 2 is flowchart representation of a method 200 of wireless communication in accordance with one or more embodiments of the present technology. The method 200 includes, at operation 210, requesting, upon determining by a first access node (e.g., the source node) to perform a handover procedure for handing over a wireless device to a second access node (e.g., the target node), a switch of an ongoing multicast and broadcast services (MBS) session of the wireless device from a shared channel to a unicast tunnel with a core network. The method 200 also includes, at operation 220, initiating, after the switching, the handover procedure from the first access node to the second access node.

In some embodiments, the method includes determining, by the first access node prior to the requesting of the switch, that the second access node does not support MBS. In some embodiments, the requesting of the switch includes transmitting, by the first access node, a request message to the core network indicating the switching to the unicast tunnel for the MBS data, and receiving, by the first access node, a confirmation message from the core network acknowledging the switching to the unicast tunnel.

In some embodiments, the request message comprises information associated with the MBS session, and the information includes at least an identifier of the MBS session or information about the shared tunnel. In some embodiments, the request message comprises information associated with the unicast tunnel, and the information includes at least an identifier of the unicast tunnel or Quality of Service (QoS) information associated with the unicast tunnel. In some embodiments, the confirmation message comprises at least information of the MBS session, information of the unicast tunnel, an acknowledgement indicator indicating the switch has completed successfully, or Quality of Service (QoS) information associated with the unicast tunnel.

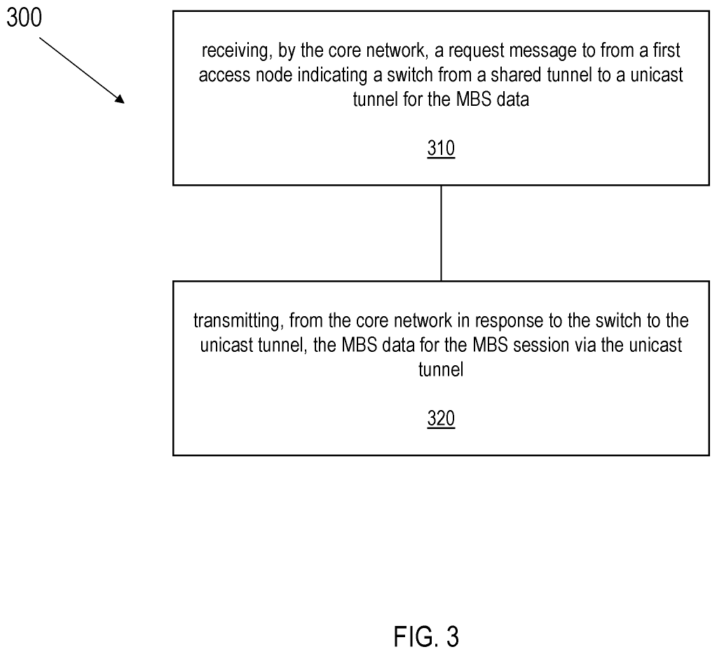

FIG. 3 is flowchart representation of a method 300 of wireless communication in accordance with one or more embodiments of the present technology. The method 300 includes, at operation 310, receiving, by the core network, a request message to from a first access node (e.g., the source node) indicating a switch from a shared tunnel to a unicast tunnel for the MBS data. The method 300 includes, at operation 320, transmitting, from the core network in response to the switch to the unicast tunnel, the MBS data for the MBS session via the unicast tunnel.

In some embodiments, the method includes transmitting, by the core network in response to the request message, a confirmation message to the first access node acknowledging the switch to the unicast tunnel. In some embodiments, the method includes performing, by the core network, a handover procedure from the first access node to a second access node (e.g., the target node) prior to transmitting the MBS data via the unicast tunnel to the second access node.

In some embodiments, the core network includes a user plane function or an access and mobility management function. In some embodiments, the request message comprises information associated with the MBS session, and the information includes at least an identifier of the MBS session or information about the shared tunnel. In some embodiments, the request message comprises information associated with the unicast tunnel, and the information includes at least an identifier of the unicast tunnel or Quality of Service (QoS) information associated with the unicast tunnel. In some embodiments, the confirmation message comprises at least information of the MBS session, information of the unicast tunnel, an acknowledgement indicator indicating the switch has completed successfully, or QoS information associated with the unicast tunnel.

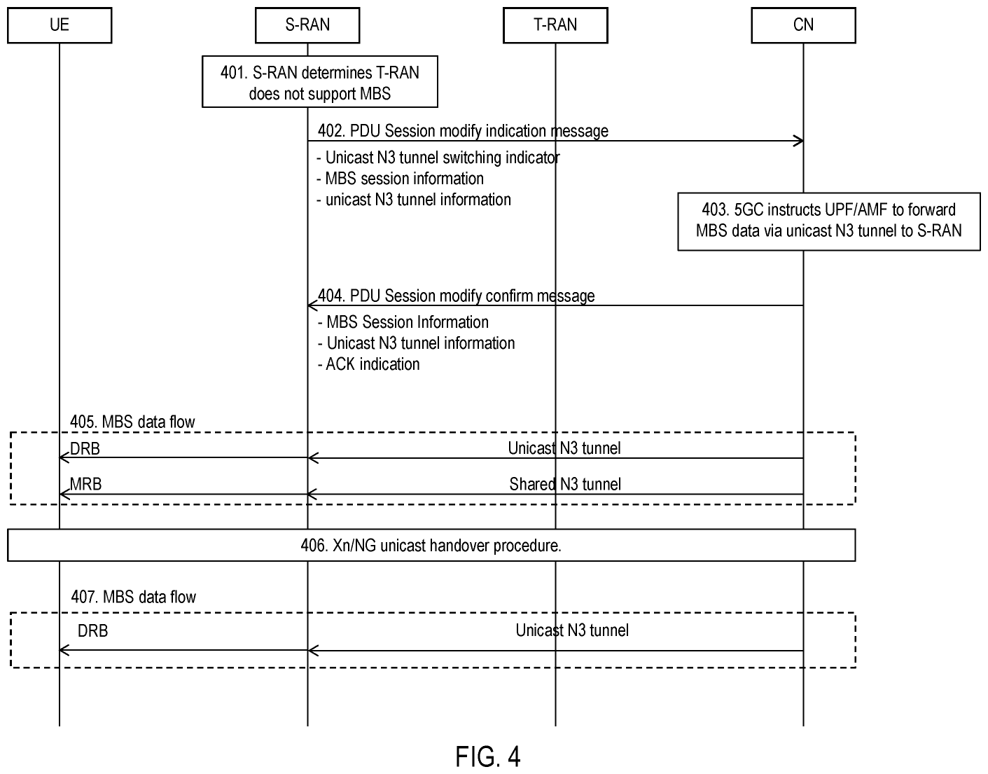

FIG. 4 illustrates an example sequence chart of signaling message between a source node and the core network in accordance with one or more embodiments of the present technology. The source NG-RAN can be provided with MBS Session Resource information, such as the MBS Session Identifier (ID) and multicast Quality of Service (QoS) flow information. The source NG-RAN can also be provided with the UE Context information that includes mapping information about the PDU Session Resource associated with the MBS Session and/or unicast/multicast QoS Flows associated with the MBS Session. Before the handover, the UE receives MBS data from the Source NG-RAN (S-RAN) via the shared N3 tunnel with the CN. The S-RAN decides to initiate handover procedure for the UE.

Operation 401: Based on the previously received information from other entities, such as information from the Operation, Administration and Maintenance (OAM) or signaling messages over the Xn interface, the S-RAN determines that the Target NG-RAN (T-RAN) does not support MBS.

Operation 402: The S-RAN transmits a request message, such as a Protocol Data Unit (PDU) Session Resource Modify Indication message, to the CN (e.g., the Access and Mobility Management Function, AMF) to request the CN to transfer MBS data through a unicast tunnel for the UE. The unicast tunnel can be a unicast N3 tunnel that has already been configured. The unicast tunnel can also be newly established for the purpose of ensuring lossless MBS data transmissions. The request message can include an indicator that indicates the switch to the unicast tunnel for MBS data transmission. The request message can further include information associated with the MBS session (e.g., MBS Session ID, existing shared N3 tunnel information) and information associated the unicast tunnel (e.g., unicast N3 tunnel ID, associated QoS info, etc.).

Operation 403: The SMF instructs the UPF to transmit MBS data via the unicast tunnel to the S-RAN. In some embodiments, the CN activates an existing unicast N3 tunnel to transmit MBS data. In some embodiments, the CN activates a newly established unicast tunnel.

Operation 404: The CN transmits a response/confirmation message, such as a PDU Session Resource Modify Confirm message, to the S-RAN. The message can include information of the MBS session (e.g., the MBS Session ID, MBS session context, MBS area scope information), information of the unicast tunnel (e.g., the tunnel ID, tunnel address, tunnel endpoint identifier), an acknowledgement indicator indicating the switch has completed successfully (e.g., a one-bit ACK indication), and/or Quality of Service (QoS) information associated with the unicast tunnel (e.g., the QoS profile).

Operation 405: After the S-RAN receives the response/confirmation message from CN, the S-RAN can receive the MBS data from CN via both unicast N3 tunnel and shared N3 tunnel. The MBS data can also be transmitted to UE via both Data Radio Bearers (DRBs) using the unicast tunnel and/or the multicast radio bearers (MRBs) using the shared tunnel. The transmitted data in these two tunnels and/or bearers can be either different or the same, given different transmission scenarios, to ensure lossless MBS data transmission during the handover.

Operation 406: The S-RAN now can initiate the handover procedure to hand the UE over to the T-RAN. As the CN is aware of the data packets that have been transmitted to the UE via the S-RAN, the CN can continue the MBS data transmission using the unicast tunnel via the T-RAN after the handover completes. There is no need for the MBS data transfer to the T-RAN via the S-RAN during the handover procedure.

### Embodiment 2

In some cases, when the UE moves from a source node to a target node, the source node that supports MBS may not be able to determine that the target node does not support MBS prior to the initiation of the handover procedure. In those cases, the source node enquires the target node (e.g., via an Xn or NG message in Xn-based on NG-based handovers) to determine whether the target node supports MBS. If the target node does not support MBS, the source node can request the CN to switch the transmission of the MBS data using a unicast tunnel.

In some embodiments, it is possible that the last data packet via the shared tunnel and first data packet via the unicast tunnel are not the same. To ensure data integrity for the MBS data transmissions, the source node can establish or use a buffer to temporarily store the received MBS data packets and forward any difference in data packets to the target node. For example, the source node can re-order the buffered data and forward the re-ordered difference to the target node. To facilitate the ordering and re-ordering of the data packets, a unique serial number can be used for each MBS data packet. The serial number can be existing number (e.g., Packet Data Convergence Protocol, PDCP, packet number) or other newly or previously defined serial number. For each MBS session, the MBS packet with the same serial number includes the same MBS data. The MBS session(s) can be mapped differently to the unicast tunnel(s). For example, a one-to-one mapping can exist between an MBS session and a unicast tunnel. As another example, multiple MBS sessions can map to a unicast tunnel. Alternatively, or in addition, an MBS session can map to multiple unicast tunnels.

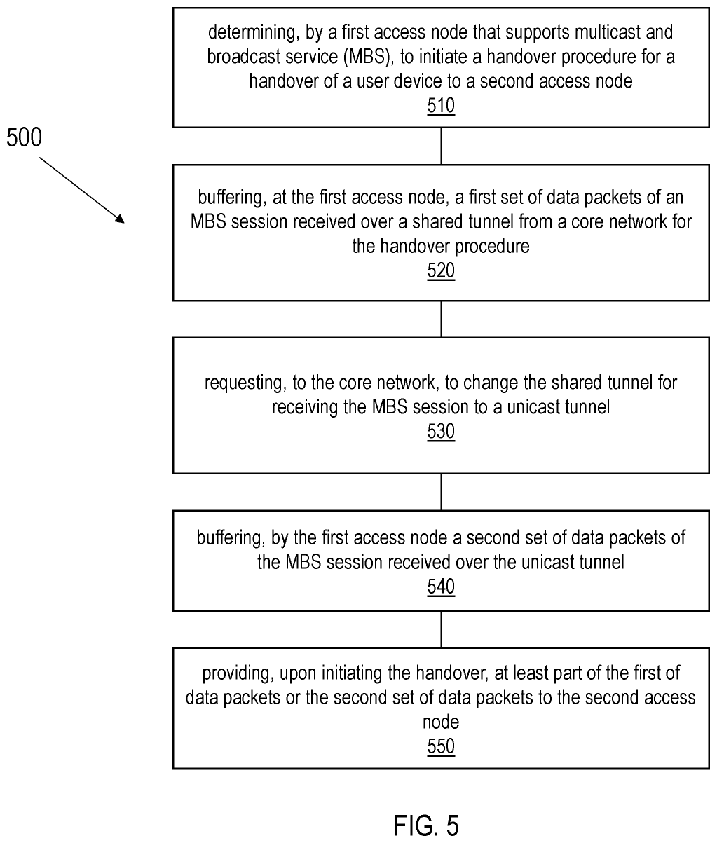

A second set of preferred solutions may include the following. FIG. 5 is flowchart representation of a method 500 of wireless communication in accordance with one or more embodiments of the present technology. The method 500 includes, at operation 510, determining, by a first access node (e.g., the source node) that supports multicast and broadcast service (MBS), to initiate a handover procedure for a handover of a user device to a second access node (e.g., the target node). The method 500 includes, at operation 520, buffering, at the first access node, a first set of data packets of an MBS session of the user device received over a shared tunnel from a core network for the handover procedure. The method 500 includes, at operation 530, requesting, to the core network, to change the shared tunnel for receiving the MBS session to a unicast tunnel. The method 500 includes, at operation 540, buffering, by the first access node a second set of data packets of the MBS session received over the unicast tunnel. The method 500 also includes, at operation 540, providing, upon initiating the handover, at least part of the first of data packets or the second set of data packets to the second access node.

In some embodiments, the method includes receiving, by the first access node, information indicating that the second access node does not support the MBS. The requesting can include initiating, by the first access node, the handover procedure by transmitting a handover request that includes information about the MBS session, and transmitting, by the first access node, a request message to the core network indicating the switch to the unicast tunnel for receiving the MBS data. In some embodiments, the method includes receiving, by the first access node, a confirmation message from the core network acknowledging the switch to the unicast tunnel.

In some embodiments, the request message comprises information associated with the MBS session, and the information includes at least an identifier of the MBS session or information about the shared tunnel. In some embodiments, the request message comprises information associated with the unicast tunnel, and the information includes at least an identifier of the unicast tunnel or Quality of Service (QoS) information associated with the unicast tunnel. In some embodiments, the confirmation message comprises at least information of the MBS session, information of the unicast tunnel, or Quality of Service (QoS) information associated with the unicast tunnel.

In some embodiments, the transmitting of the handover request comprises transmitting, by the first access node, the handover request to the second access node (e.g., for Xn based handover). In some embodiments, the transmitting of the handover request comprises transmitting, by the first access node, the handover request to the second access node via the core network (e.g., for NG based handover).

In some embodiments, each of the first set and the second set of MBS data packets is associated with a unique sequence number. The method further includes re-ordering the first set and the second set of MBS data packets based on the respective unique sequence number prior to forwarding the at least part of the first set and/or the second set of MBS data packets to the second access node. In some embodiments, the buffer is associated with the MBS session, the buffer being a user equipment specific buffer or a common buffer. In some embodiments, the core network includes a user plane function or an access and mobility management function.

The behavior of the core network is similar to what has been described in connection with FIG. 3. It is noted in some embodiments, the transmitting of the MBS data for the MBS session via the unicast tunnel comprises transmitting, by the core network, the MBS data via the unicast tunnel to the first access node as part of a handover procedure from the first access node to a second access node.

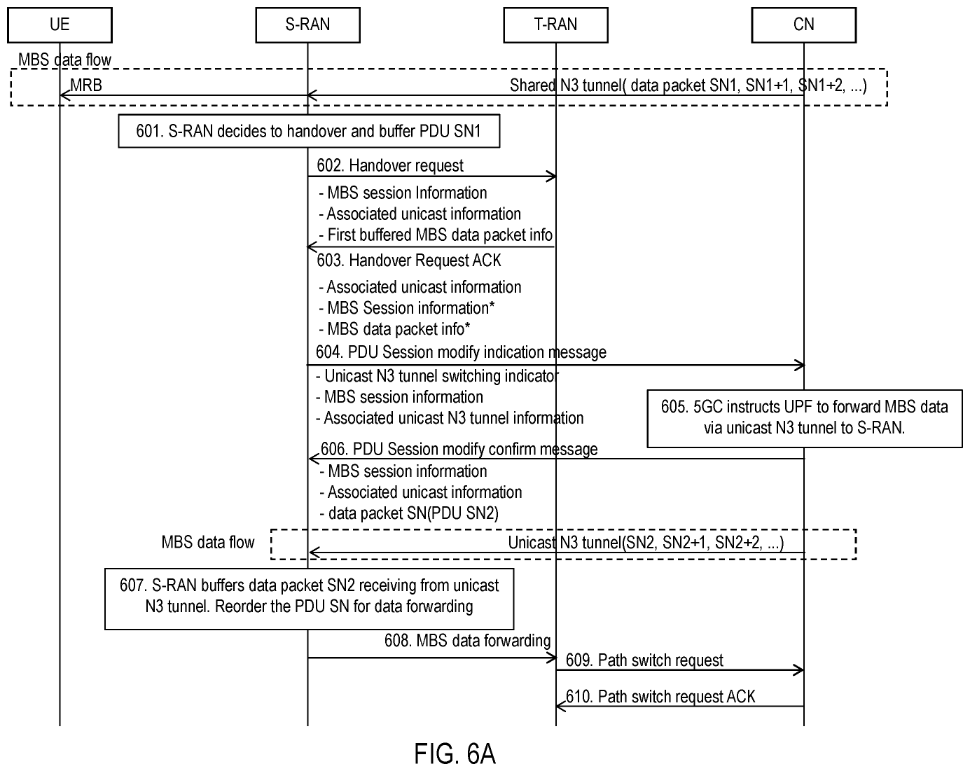

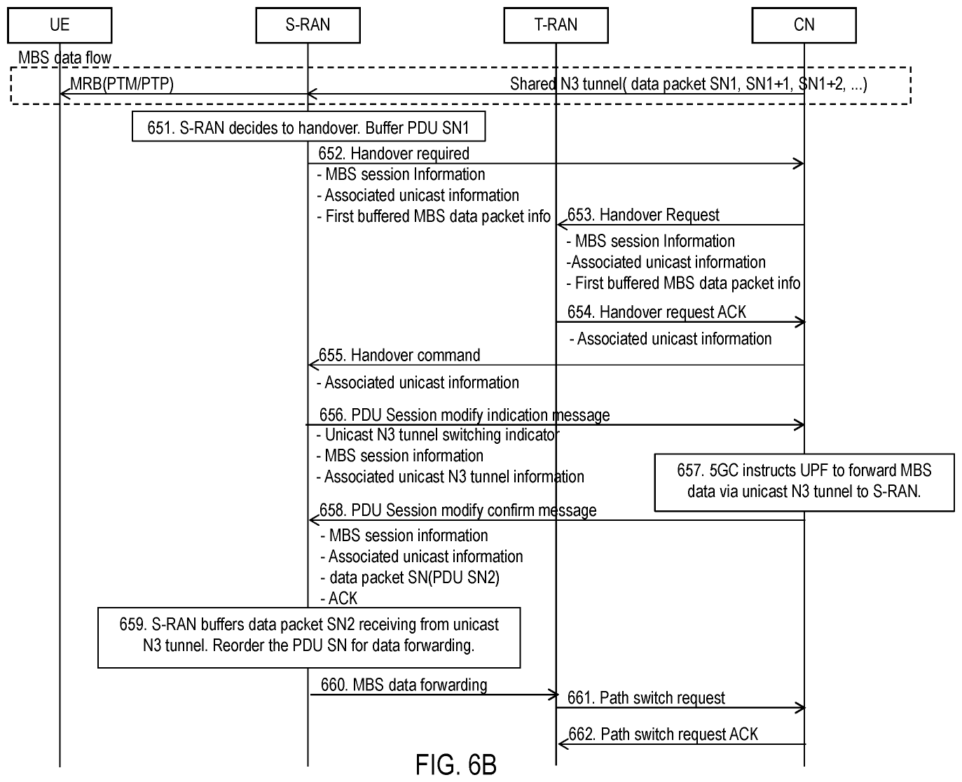

FIG. 6A illustrates an example sequence chart of signaling message between a source node, a target node, and the core network using the NG-based handover procedure in accordance with one or more embodiments of the present technology. Before the handover, the UE receives MBS data from the Source NG-RAN (S-RAN) via the shared N3 tunnel with the CN.

Operation 601: Based on the collected information, the S-RAN decides to trigger the handover procedure for the UE. The S-RAN then uses a buffer to store the MBS data packets for this MBS session for the handover. The S-RAN can use an existing established buffer or setup a new one. The buffer can be a UE-specific or a common buffer for the MBS session to store data for the handover. For example, as shown in FIG. 6A, the S-RAN stores the first MBS packet in the buffer with a sequence number 1 (e.g., SN1).

Operation 602: The S-RAN sends a request message, such as an Xn Handover Request message, to the T-RAN. The request message includes the MBS related information, such as MBS session information(e.g., MBS session ID, MBS session context, MBS area scope information, shared N3 tunnel info such as tunnel ID, tunnel address, tunnel endpoint identifier, associated QoS info, etc.), associated unicast N3 tunnel information(e.g., unicast N3 tunnel ID, tunnel address, tunnel endpoint identifier, associated QoS info, etc.), and/or information about the buffered MBS data packet(s) (e.g., serial number, packet number, etc.).

Operation 603: The T-RAN transmits a response/acknowledgement message, such as an Xn Handover Request Acknowledgment, to the S-RAN. If the T-RAN supports the MBS, the response/acknowledgement message includes MBS related information (e.g., MBS session ID, MBS session context, MBS area scope information, shared N3 tunnel info such as tunnel ID, tunnel address, tunnel endpoint ID, and/or associated QoS info, etc.) and/or information about the MBS data packet(s) (e.g., serial number(s), packet number(s), etc.). If the T-RAN does not support MBS, the MBS related information is omitted from the response message. If the S-RAN cannot find any corresponding MBS information in the response/acknowledgement message, the S-RAN can determine that the T-RAN does not support MBS.

Operation 604: When there is only unicast information in the Xn response message, the S-RAN determines that the T-RAN does not support MBS. Hence, the S-RAN transmits a request message (e.g., PDU Session Resource Modify Indication message) to the CN and requests the CN to switch the MBS data from N3 shared tunnel to a unicast tunnel. The request message can include one or more of the following: an indicator indicating a switch from the shared tunnel to a unicast tunnel for MBS data transmission, MBS session information(e.g., MBS Session ID, MBS session context, MBS area scope information, shared N3 tunnel info such as tunnel ID, tunnel address, tunnel endpoint ID, etc.), and/or associated unicast N3 tunnel information(e.g., unicast N3 tunnel ID, associated QoS info, etc.).

Operation 605: The CN (e.g., UPF) starts to transmit MBS data via unicast N3 tunnel to the S-RAN.

Operation 606: The CN (e.g., AMF) transmits a response message, such as PDU Session Resource Modify Confirm message, to the S-RAN confirming that the switch has been successful. The response message can include the MBS session information(e.g., MBS session ID, MBS session context, MBS area scope information, shared N3 tunnel info such as tunnel ID, tunnel address, tunnel endpoint ID, and/or associated QoS info, etc.), the associated unicast information(e.g., unicast N3 tunnel ID, tunnel address, tunnel endpoint ID, and/or associated QoS info, etc.), and/or the SN of the first MBS data packet transmitted via the unicast N3 tunnel (e.g., PDU SN2). After receiving the response message, the S-RAN can receive the MBS data from the unicast N3 tunnel.

Operation 607: The S-RAN buffers MBS data packets received using the unicast N3 tunnel. It then re-orders the received packets using the packet SNs to determine whether there is any difference or data loss during the handover.

Operation 608: The S-RAN can forward at least part of the re-ordered MBS data packets to the T-RAN to ensure the data integrity of MBS data transmissions.

Operation 609: The T-RAN transmits a Path Switch Request to the CN as a part of the handover procedure.

Operation 610: The CN transmits a Path Switch Request Acknowledge to the T-RAN indicating that the handover has been completed. The T-RAN now can continue to relay MBS data to the UE using the unicast tunnel.

FIG. 6B illustrates an example sequence chart of signaling message between a source node, a target node, and the core network using the NG-based handover procedure in accordance with one or more embodiments of the present technology. Before the handover, the UE receives MBS data from the S-RAN via the shared N3 tunnel with the CN. Operation 651 is similar to Operation 601 in FIG. 6A.

Operation 652: The S-RAN transmits a request message (e.g., a Handover Required message) to the CN. The message includes the MBS related information, such as MBS session information(e.g., MBS session ID, MBS session context, MBS area scope information, shared N3 tunnel info such as tunnel ID, tunnel address, tunnel endpoint ID, and/or associated QoS info, etc.), associated unicast N3 tunnel information(e.g., unicast N3 tunnel ID, tunnel address, tunnel endpoint ID, and/or associated QoS info, etc.), and the information about the buffered MBS data packet(s) (e.g., serial number(s), packet number(s)).

Operation 653: The CN transmits a request message (e.g., a Handover Request message) to the T-RAN. The message relays the MBS related information from the S-RAN, such as MBS session information(e.g., MBS session ID, MBS session context, MBS area scope information, shared N3 tunnel info such as tunnel ID, tunnel address, tunnel endpoint ID, and/or associated QoS info, etc.), associated unicast N3 tunnel information(e.g., unicast N3 tunnel ID, tunnel address, tunnel endpoint ID, and/or associated QoS info, etc.), and the information about the buffered MBS data packet(s) (e.g., serial number(s), packet number(s)).

Operation 654: The T-RAN transmits a response/acknowledgement message (e.g., a Handover Request Acknowledge message) to the CN. If the T-RAN supports the MBS, the response/acknowledgement message includes MBS related information (e.g., MBS session ID, shared N3 tunnel info, associated QoS info, etc.) and/or information about the MBS data packet(s) (e.g., serial number(s), packet number(s), etc.). If the T-RAN does not support MBS, the MBS related information is omitted from the response message.

Operation 655: The CN relays the information received from the T-RAN in a response massage (e.g., Handover Command) transmitted to the S-RAN. The S-RAN does not know whether the T-RAN supports MBS until the S-RAN receives the response message from the CN. If the S-RAN cannot find any corresponding MBS information in the response message, the S-RAN can determine that the T-RAN does not support MBS.

Operations 656-662 are similar to Operations 604-610 described in connection with FIG. 6A.

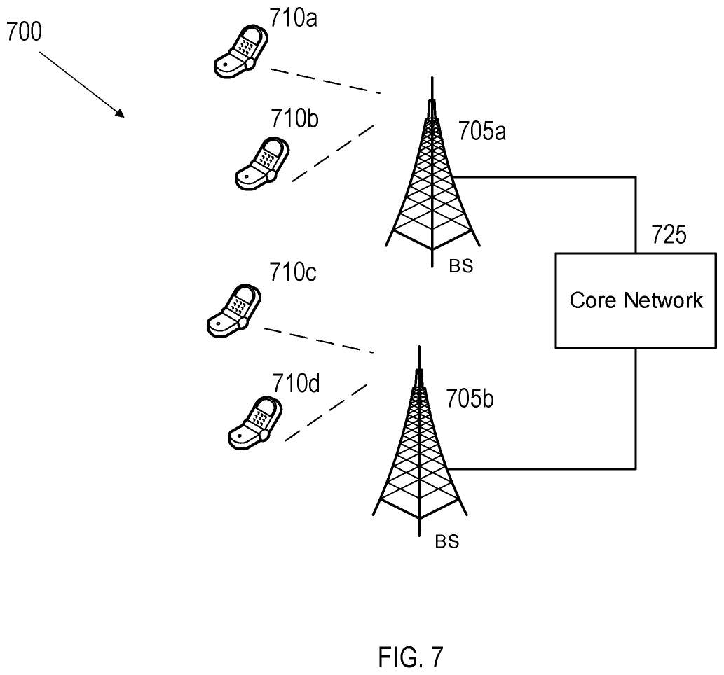

FIG. 7 shows an example of a wireless communication system 700 where techniques in accordance with one or more embodiments of the present technology can be applied. A wireless communication system 700 can include one or more base stations (BSs) 705a, 705b, one or more wireless devices 710a, 710b, 710c, 710d, and a core network 725. A base station 705a, 705b can provide wireless service to wireless devices 710a, 710b, 710c and 710d in one or more wireless sectors. In some implementations, a base station 705a, 705b includes directional antennas to produce two or more directional beams to provide wireless coverage in different sectors. The core network 725 can communicate with one or more base stations 705a, 705b. The core network 725 provides connectivity with other wireless communication systems and wired communication systems. The core network may include one or more service subscription databases to store information related to the subscribed wireless devices 710a, 710b, 710c, and 710d. A first base station 705a can provide wireless service based on a first radio access technology, whereas a second base station 705b can provide wireless service based on a second radio access technology. The base stations 705a and 705b may be co-located or may be separately installed in the field according to the deployment scenario. The wireless devices 710a, 710b, 710c, and 710d can support multiple different radio access technologies. The techniques and embodiments described in the present document may be implemented by the base stations of wireless devices described in the present document.

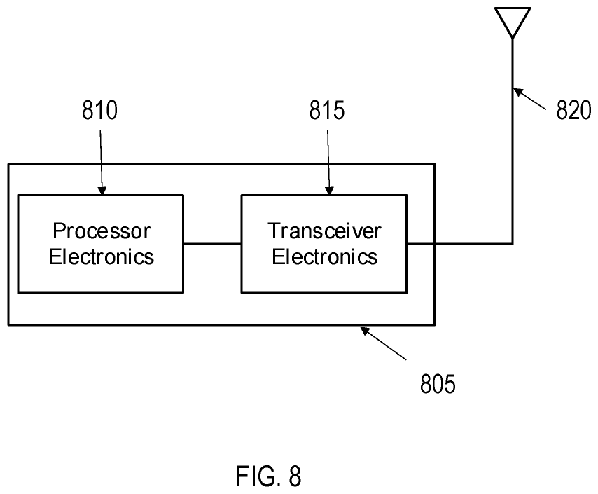

FIG. 8 is a block diagram representation of a portion of a radio station in accordance with one or more embodiments of the present technology can be applied. A radio station 805 such as an access node, a base station or a wireless device (or UE) can include processor electronics 810 such as a microprocessor that implements one or more of the wireless techniques presented in this document. The radio station 805 can include transceiver electronics 815 to send and/or receive wireless signals over one or more communication interfaces such as antenna 820. The radio station 805 can include other communication interfaces for transmitting and receiving data. Radio station 805 can include one or more memories (not explicitly shown) configured to store information such as data and/or instructions. In some implementations, the processor electronics 810 can include at least a portion of the transceiver electronics 815. In some embodiments, at least some of the disclosed techniques, modules or functions are implemented using the radio station 805. In some embodiments, the radio station 805 may be configured to perform the methods described herein.

It will be appreciated that the present document discloses techniques that can be embodied in various embodiments to ensure lossless MBS data transmissions without introducing additional signaling overhead between the source/target base stations and the core network. The disclosed techniques can be used in different handover scenarios, depending on the information associated with the T-RAN that is known to the S-RAN. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method of wireless communication, comprising:
requesting, upon determining by a first access node to perform a handover procedure for handing over a wireless device to a second access node, a switch of an ongoing multicast and broadcast services (MBS) session of the wireless device from a shared tunnel to a unicast tunnel with a core network; and
initiating, after the switch, the handover procedure from the first access node to the second access node.

2. The method of claim 1, comprising:
determining, by the first access node prior to requesting the switch, that the second access node does not support MBS.

3. The method of claim 1, wherein requesting the switch comprises:
transmitting, by the first access node, a request message to the core network indicating the switch to the unicast tunnel for MBS data for the ongoing MBS session, and
receiving, by the first access node, a confirmation message from the core network acknowledging the switch to the unicast tunnel.

4. The method of claim 3, wherein the request message comprises information associated with the ongoing MBS session, and wherein the information includes an identifier of the ongoing MBS session or information regarding the shared tunnel.

5. The method of claim 3, wherein the request message comprises information associated with the unicast tunnel, and wherein the information includes an identifier of the unicast tunnel or Quality of Service (QoS) information associated with the unicast tunnel.

6. The method of claim 3, wherein the confirmation message comprises at least one of information of the ongoing MBS session, information of the unicast tunnel, an acknowledgement indicator indicating the switch has completed successfully, or Quality of Service (QoS) information associated with the unicast tunnel.

7. A method for wireless communications, comprising:
receiving, by a core network, a request message from a first access node indicating a switch from a shared tunnel to a unicast tunnel for multicast and broadcast services (MBS) data for an ongoing MBS session; and
transmitting, in response to the switch to the unicast tunnel, the MBS data for the ongoing MBS session via the unicast tunnel.

8. The method of claim 7, comprising:
transmitting, in response to the request message, a confirmation message to the first access node acknowledging the switch to the unicast tunnel.

9. The method of claim 7, further comprising:
performing, by the core network, a handover procedure from the first access node to a second access node prior to transmitting the MBS data via the unicast tunnel to the second access node.

10. The method of claim 7, wherein the core network includes a user plane function or an access and mobility management function.

11. The method of claim 7, wherein the request message comprises information associated with the ongoing MBS session, and wherein the information includes an identifier of the ongoing MBS session or information regarding the shared tunnel.

12. The method of claim 7, wherein the request message comprises information associated with the unicast tunnel, and wherein the information includes an identifier of the unicast tunnel or Quality of Service (QoS) information associated with the unicast tunnel.

13. The method of claim 8, wherein the confirmation message comprises at least one of information of the ongoing MBS session, information of the unicast tunnel, an acknowledgement indicator indicating the switch has completed successfully, or Quality of Service (QoS) information associated with the unicast tunnel.

14. An apparatus for wireless communication, comprising:
at least one processor configured to:
request, upon determining by a first access node to perform a handover procedure for handing over a wireless device to a second access node, a switch of an ongoing multicast and broadcast services (MBS) session of the wireless device from a shared tunnel to a unicast tunnel with a core network; and
initiate, after the switch, the handover procedure from the first access node to the second access node.

15. The apparatus of claim 14, wherein the at least one processor is configured to:
determine, prior to requesting the switch, that the second access node does not support MBS.

16. The apparatus of claim 14, wherein the at least one processor is configured, as part of requesting the switch, to:
transmit a request message to the core network indicating the switch to the unicast tunnel for MBS data for the ongoing MBS session; and
receive a confirmation message from the core network acknowledging the switch to the unicast tunnel.

17. An apparatus for wireless communication, comprising:
at least one processor configured to:
receive, by a core network, a request message from a first access node indicating a switch from a shared tunnel to a unicast tunnel for multicast and broadcast services (MBS) data for an ongoing MBS session; and
transmit, in response to the switch to the unicast tunnel, the MBS data for the ongoing MBS session via the unicast tunnel.

18. The apparatus of claim 17, wherein the at least one processor is configured to:
transmit, in response to the request message, a confirmation message to the first access node acknowledging the switch to the unicast tunnel.

19. The apparatus of claim 17, wherein the at least one processor is further configured to:
perform a handover procedure from the first access node to a second access node prior to transmitting the MBS data via the unicast tunnel to the second access node.

20. The apparatus of claim 17, wherein the core network includes a user plane function or an access and mobility management function.

21. The apparatus of claim 17, wherein the request message comprises information associated with the unicast tunnel, and wherein the information includes an identifier of the unicast tunnel or Quality of Service (QoS) information associated with the unicast tunnel.
